(19) United States
(12) Patent Application Publication
(10) Pub. No.: US 2015/0177848 A1
(43) Pub. Date: Jun. 25, 2015

(54) DISPLAY APPARATUS AND CONTROL METHOD THEREOF

(71) Applicant: SAMSUNG ELECTRONICS CO., LTD., Suwon-si (KR)

(72) Inventors: Ji-su JUNG, Yongin-si (KR); Hyo-in AHN, Seoul (KR); Eun-kyung YOO, Seoul (KR); Dong-Goo KANG, Seoul (KR); Say JANG, Yongin-si (KR)

(21) Appl. No.: 14/560,552

(22) Filed: Dec. 4, 2014

(30) Foreign Application Priority Data
Dec. 20, 2013 (KR) 10-2013-0160193

(51) Int. Cl. G06F 3/02; G06F 3/0488; G06F 3/0482

(52) U.S. Cl. CPC G06F 3/02; G06F 3/0482; G06F 3/0488

(57) ABSTRACT

A display apparatus includes: a display; a processor configured to process a content image to be displayed on the display; a storage configured to store a database where control commands for controlling operations of the processor corresponding to a plurality of pieces of the rotation information and a plurality of pieces of the touch information are designated according to kinds of contents; and a controller configured to determine a kind of content corresponding to the content image being displayed on the display in response to receiving at least one from among rotation information corresponding to a user's rotating operation and touch information corresponding to a user's touching operation, from an input device, and configured to control the processor to execute a control command corresponding to the received rotation information or the received touch information from the database based on the determined kind of content.

### CROSS-REFERENCE TO RELATED APPLICATION

This application claims priority from Korean Patent Application No. 10-2013-0160193, filed on Dec. 20, 2013 in the Korean Intellectual Property Office, the disclosure of which is incorporated herein by reference in its entirety.

### BACKGROUND

1. Field

Apparatuses and methods consistent with the exemplary embodiments relate to a display apparatus capable of processing content data and displaying it as a content image and a control method thereof, and more particularly to a display apparatus and a control method thereof, in which operation control about a content image is performed through an input device remotely controlled by a user.

2. Description of the Related Art

An image processing apparatus for processing image data to be finally displayed as an image is classified into a type of apparatus for displaying an image based on the processed image signal with a built-in display panel, and a type of apparatus (without a display panel) for outputting the processed image signal to another device. The former is generally called a display apparatus. As an example of the display apparatus, there are a television (TV), a monitor, an electronic blackboard, etc.

To meet various demands of users and with the development of various functions of the display apparatus, the kind of contents displayable as an image by the display apparatus has increased. For example, the contents include a web page, a text document, a slide document, a still image, a thumbnail image or a user interface (UI) image containing an icon, etc. as well as a general moving image content. Such contents are received from the exterior through various communication interfaces provided in the display apparatus, or read from a built-in storage of the display apparatus.

Also, the display apparatus provides various kinds of user input interfaces so that a user can control or select an operation related to the content image displayed on the display apparatus. With development of the display apparatus, a voice recognition structure, a gesture recognition structure or a similar user input interface has recently been used. However, a remote controller has been used as a basic user input interface. The remote controller is an additional input device provided separately and remotely from the display apparatus and including a plurality of physical buttons. When a user presses a certain button, the remote controller sends the display apparatus a control command mapped to the pressed button.

### SUMMARY

According to an aspect of an exemplary embodiment, a display apparatus includes: a display; a processor configured to process a content image to be displayed on the display; a storage configured to store a database where control commands for controlling operations of the processor corresponding to a plurality of pieces of the rotation information and a plurality of pieces of the touch information are designated according to kinds of contents; and a controller configured to determine a kind of content corresponding to the content image being displayed on the display in response to receiving at least one of the rotation information corresponding to a user's rotating operation and touch information corresponding to a user's touching operation, from an input device, and configured to control the processor to execute a control command corresponding to the received rotation information or the received touch information from the database based on the determined kind of content.

The controller may invoke information of the control command corresponding to at least one from among the rotation information and the touch information with regard to the determined kind of content from the database, and may select the control command corresponding to at least one from among the rotation information and the touch information received from the input device among the invoked pieces of information.

The controller may control to display a user interface (UI) image provided for designating information of the control command with respect to the determined kind of contents in response to the determination that the database includes no information of the control command with respect to the determined kind of content, and may update the database with a user setting through the UI image.

The display apparatus may further include a bezel formed at an edge of the display, wherein the controller may detect a position of the bezel, where the input device is supportable, in response to receiving at least one from among the rotation information and the touch information from the input device while the input device is being supported at the position of the bezel, and may control to display a menu image at a position with reference to the detected position of the bezel, and the menu image may include information about the control command corresponding to at least one from among the received rotation information and the received touch information.

The controller may control to display the menu image on the display within a preset distance range from the detected position of the bezel.

The input device may be remotely separated from the display apparatus.

The input device may include: a lower housing; an upper housing laid on the lower housing and rotatable with respect to the lower housing; a touch region installed on a top of the upper housing; a sensor configured to sense rotation of the upper housing and touch of the touch region; and an input device controller configured to generate and output at least one from among the rotation information and the touch information based on a sensing result of the sensor.

The sensor may include: a rotation sensor configured to sense a rotation direction and amount of the upper housing; a touch sensor configured to sense a user's touch on the touch region.

The input device may include a light emitting line installed in the upper housing, and the input device controller controls a light emitting state of the light emitting line in accordance with change in the rotation amount of the upper housing.

The input device controller may change a color of the light emitting line so as to control the light emitting state of the light emitting line.

The controller may determine the kind of content having the highest priority in a previously designated order among a plurality of content images in response to receiving at least one from among the rotation information and the touch information from the input device while the plurality of content images are displayed together on the display, and may search the control command based on the determined kind of content.

According to an aspect of another exemplary embodiment, a method of controlling a display apparatus include: displaying a content image; receiving at least one from among rotation information corresponding to a user's rotating operation and touch information corresponding to a user's touching operation from an input device; determining a kind of content corresponding to the displayed content image; and executing a control command corresponding to at least one from among the rotation information and the touch information received from the input device based on the determined kind of content, from a database where control commands for controlling operations of the processor corresponding to a plurality of pieces of the rotation information and a plurality of pieces of the touch information are designated according to kinds of content.

The executing the control command may include: invoking information of the control command corresponding to at least one from among the rotation information and the touch information with regard to the determined kind of content from the database; and selecting the control command corresponding to the at least one from among rotation information and the touch information received from the input device among the invoked pieces of information.

The executing the control command may include: displaying a user interface (UI) image provided for designating information related to the control command with respect to the determined kind of content in response to a determination that the database includes no information of the control command with respect to the determined kind of content; and updating the database with a user setting through the UI image.

The method may further include: detecting a position of a bezel where the input device is supported, in response to receiving at least one from among the rotation information and the touch information from the input device while the input device is being supported at the position of the bezel of the display apparatus; and displaying a menu image at a position with reference to the detected position of the bezel, wherein the menu image may include information related to the control command corresponding to the at least one from among received rotation information and the received touch information.

The displaying the menu image may include displaying the menu image on the display within a preset distance range from the detected position of the bezel.

The determining the kind of content corresponding to the displayed content image may include determining the kind of content having a highest priority in a previously designated order among a plurality of content images, in response to receiving at least one from among the rotation information and the touch information from the input device while the plurality of content images are displayed together on the display apparatus.

According to an aspect of another exemplary embodiment, there is provided a system comprising the above-described display apparatus and an input device configured to output at least one from among rotation information corresponding to a user's rotating operation and touch information corresponding to a user's touching operation.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram of a display apparatus according to a first exemplary embodiment;

FIG. 2 is a perspective view of an input device that communicates with the display apparatus of FIG. 1;

FIG. 3 shows an example where the input device of FIG. 2 is gripped by a user;

FIG. 4 is a block diagram of the input device of FIG. 2;

FIGS. 5 and 6 are flowcharts showing a method of controlling the display apparatus of FIG. 1;

FIG. 7 shows an example of database stored in the display apparatus of FIG. 1;

FIGS. 8 and 9 show examples where the input device is operated while a moving image is displayed on the display apparatus of FIG. 1;

FIG. 10 shows an example where the input device is operated while an UI image having a thumbnail image is displayed on the display apparatus of FIG. 1; and

FIG. 11 shows an example where an input device is mounted to a bezel of a display apparatus according to a second exemplary embodiment.

### DETAILED DESCRIPTION OF EXEMPLARY EMBODIMENTS

Below, exemplary embodiments will be described in detail with reference to accompanying drawings. In the following exemplary embodiments, only elements directly related to the exemplary embodiment will be described, and descriptions about the other elements will be omitted. However, it will be appreciated that the elements, the descriptions of which are omitted, are not unnecessary to realize the apparatus or system according to the exemplary embodiments.

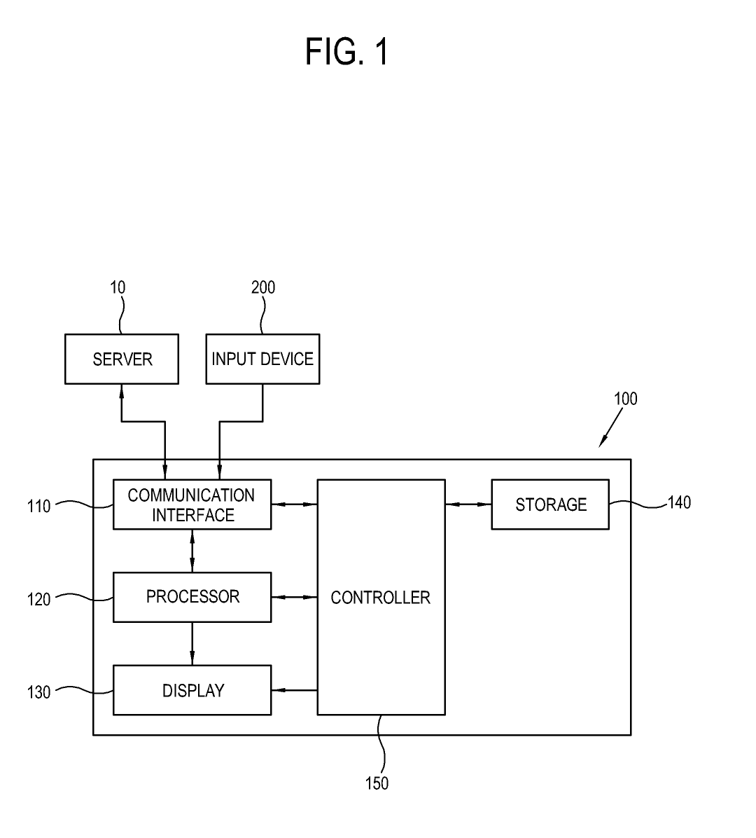

FIG. 1 is a block diagram of a display apparatus 100 according to a first exemplary embodiment. In this exemplary embodiment, the display apparatus 100 processes image data of contents received from the exterior or stored therein and displays it as a content image. The display apparatus 100 according to this exemplary embodiment is achieved by a television (TV), but not limited thereto. Alternatively, the exemplary embodiment may be achieved by various display apparatus such as an electronic blackboard or the like as long as it can process the image data and display it as an image.

Referring to FIG. 1, the display apparatus 100 includes a communication interface 110 which communicates with the exterior to transmit and receive data/a signal; a processor 120 which processes the data received in the communication interface 110 in accordance with a preset process; a display 130 which displays image data as an image if the data processed by the processor 120 is the image data; a storage 140 which stores data/information; and a controller 150 which operates and controls general operations the display apparatus 100 such as the processor 120.

Here, the display apparatus 100 includes an input device 200 separated from the display apparatus 100, and receives preset input information or input data from the input device 200 through local wireless communication. Thus, the display apparatus 100 and the input device 200 constitute a system.

Below, the foregoing elements of the display apparatus 100 will be described in detail.

The communication interface 110 transmits/receives data so that interactive communication can be performed between the display apparatus 100 and various external devices. The communication interface 110 accesses one or more external devices through wired/wireless wide/local area networks or locally in accordance with preset communication protocols. For example, the communication interface 110 accesses a server 10 through a wide area network and also locally accesses the input device 200.

The communication interface 110 may be achieved by connection ports according to devices or an assembly of connection modules, in which the protocol for connection or a target for connection is not limited to one kind. That is, the communication interface 110 may simultaneously communicate with a plurality of external devices through a plurality of protocols. The communication interface 110 may be internally provided in a housing (not shown) of the display apparatus 100, but is not limited thereto. Alternatively, the entire or a part of the communication interface 110 may be added to the display apparatus 100 in the form of an add-on or dongle type.

The communication interface 110 transmits/receives a signal in accordance with protocols designated according to the connected devices, in which the signals can be transmitted/received based on individual connection protocols with regard to the connected devices. In the case of image data, the communication interface 110 may transmit/receive the signal based on various standards such as a radio frequency (RF) signal, composite/component video, super video, Syndicat des Constructeurs des Appareils Radiorécepteurs et Téléviseurs (SCART), high definition multimedia interface (HDMI), display port, unified display interface (UDI), or wireless HD, etc.

The processor 120 performs various processes with regard to data/a signal received in the communication interface 110. If the communication interface 110 receives the image data, the processor 120 applies an imaging process to the image data and the image data processed by this process is output the display 130, thereby allowing the display 130 to display an image based on the corresponding image data. If the signal received in the communication interface 110 is a broadcasting signal, the processor 120 extracts video, audio and appended data from the broadcasting signal tuned to a certain channel, and adjusts an image to have a preset resolution, so that the image can be displayed on the display 130.

There is no limit to the kind of imaging processes to be performed by the processor 120. For example, there are decoding corresponding to an image format of the image data, de-interlacing for converting the image data from an interlace type into a progressive type, scaling for adjusting the image data to have a preset resolution, noise reduction for improving image qualities, detail enhancement, frame refresh rate conversion, etc.

The processor 120 may perform various processes in accordance with the kinds and attributes of data, and thus the process to be implemented in the processor 120 is not limited to the imaging process. Also, the data processible in the processor 120 is not limited to only that received in the communication interface 110. For example, the processor 120 processes a user's speech through a preset voicing process when the corresponding speech is received through a separately provided microphone (not shown), and processes a sensing result through a preset gesture process when a user's gesture is sensed by a separately provided camera (not shown).

The processor 120 may be achieved by an image processing board (not shown) where a system-on-chip where various functions are integrated or an individual chip-set capable of independently performing each process, is mounted on a printed circuit board. The processor 120 may be built-in the display apparatus 100.

The display 130 displays the video signal/the image data processed by the processor 120 as an image. The display 130 may be achieved by various display types such as liquid crystal, plasma, a light-emitting diode, an organic light-diode, a surface-conduction electron-emitter, a carbon nano-tube and a nano-crystal, but is not limited thereto.

The display 130 may additionally include an appended element based on the type of display it is. For example, in the case of the liquid crystal type, the display 130 may include a liquid crystal display (LCD) panel (not shown), a backlight unit (not shown) which emits light to the LCD panel, a panel driving substrate (not shown) which drives the panel (not shown), etc.

The storage 140 stores various pieces of data. The storage 140 is achieved by a nonvolatile memory such as a flash memory, a hard disk drive, etc. so as to retain data regardless of power on/off of the system. The storage 140 is accessed by the controller 150 so that previously stored data can be read, recorded, modified, deleted, updated, and so on.

The controller 150 controls operations of the display apparatus 100, such as the processor 120, in response to occurrence of a preset event. For example, if the communication interface 110 receives the image data of predetermined contents, the controller 150 controls the processor 120 to process the image data to be displayed as an image on the display 130. Also, if the communication interface 110 receives a control command or information input by a user, the controller 150 controls an operation, which is previously designated corresponding to the received control command or input information, to be performed.

Below, the input device 200 will be described in more detail.

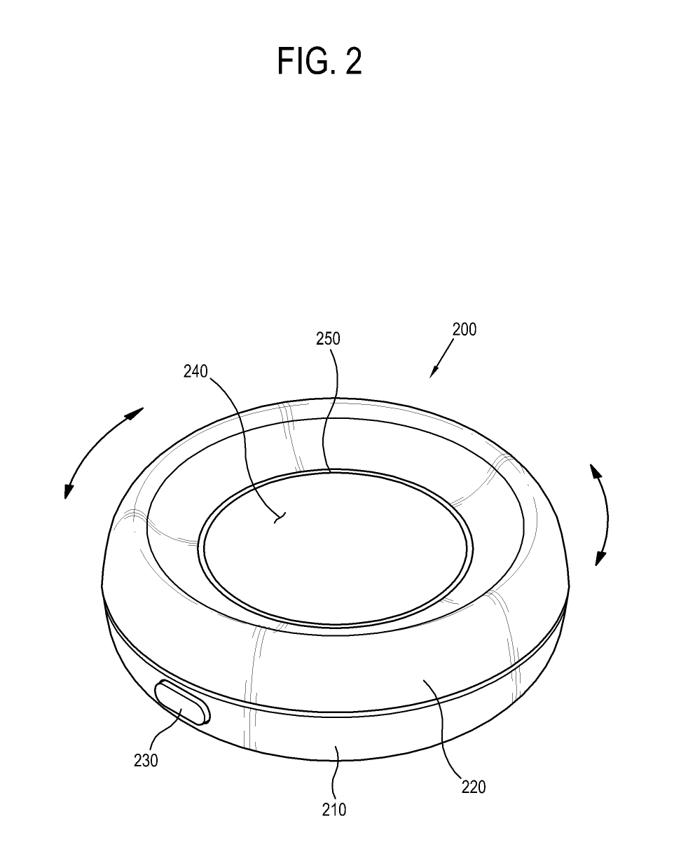

FIG. 2 is a perspective view of an input device 200.

Referring to FIG. 2, the input device 200 is shaped like a circular plate, however the shape of the input device 200 is not limited thereto. The input device 200 includes a lower housing 210 forming a lower side of the input device 200, and an upper housing 220 forming an upper side of the input device 200 and provided on the lower housing 210. Here, the lower side and the upper side refer to relative positions in the drawings, and these expressions do not limit the structure of the input device 200.

Also, the input device 200 includes a power button 230 installed at a lateral wall of the lower housing 210, a touch region 240 installed on the top of the upper housing 220, and a light feedback line 250 installed around the touch region 240. The power button 230, touch region 240, and light feedback line 250 may also be provided at portions of the input device 200 other than those mentioned above.

With this structure, the input device 200 is provided in such a manner that the upper housing 220 can be rotated with respect to the lower housing 210. The upper housing 220 is rotatable with respect to the lower housing 210 but not separable from the lower housing 210. To achieve this structure, various shapes may be applied in accordance with designs.

The power button 230 comprises a toggle button or an on/off button provided so that a user can turn on or off the display apparatus 100. If a user operates the power button 230, the display apparatus 100 switches between a power-on state and a power-off state.

The touch region 240 is touched with a user's finger or the like, and thus generates sensing information corresponding to a user's touch moving operation or a user's tap operation. The touch region 240 serves as a general touch pad or a touch sensor. The touch region 240 may be recessed from an upper plate of the upper housing 220 at a predetermined depth in order to prevent the finger from being easily deviated from the touch region 240 when it is touched with a user's fingertips.

The light feedback line 250 forms a circular line around the touch region 240 or along a top edge of the upper housing 220. The light feedback line 250 is installed at a position where at least a part thereof can be seen by a user's naked eyes when s/he grips the input device 200 and touches the touch region 240. However, there is no limit to the installed position of the light feedback line 250.

The light feedback line 250 is formed by arranging light emitting diodes (LEDs) corresponding to one or more colors. The light feedback line 250 is provided to vary in a light emitting state as a rotation amount or rotation angle of the upper housing 220 increases when a user rotates the upper housing 220 with respect to the lower housing 210. The variation in the light emitting state may be achieved by various methods. For example, the light feedback line 250 may have a structure of varying in color of light, or varying in a light emitting position. Thus, a user can intuitively recognize an approximate rotation amount or rotation state of the upper housing 220.

For example, the light feedback line 250 emits yellow light in an initial state where the upper housing 220 is not rotated, and varies in the color of the light in order of red, violet, blue, etc. as the upper housing 220 starts to rotate and increases in the rotation amount. However, this method is just an example, and does not limit the exemplary embodiment of the light feedback line 250.

With this structure, the input device 200 according to this exemplary embodiment generates input information such as rotation amount information based on the rotation of the upper housing 220, and touch information based on touch of the touch region 240. The input device 200 wirelessly transmits the generated input information to the display apparatus 100.

The rotation amount information refers to information obtained by digitizing how much the upper housing 220 is rotated with respect to the lower housing 210. The rotation amount information may be achieved in various forms such as a rotation direction of the upper housing 220, a rotation angle of the upper housing 220, the number of rotations of the upper housing 220, etc.

The touch information refers to information about an operation where a user touches the touch region 240. For example, the touch operation includes a tap operation that a user touches a certain position of the touch region 240 with a finger and takes the finger off the touch region 240, a double-tap operation that the double tap operations are successively performed twice, a long tap operation that a user touches the touch region 240 with a finger and takes the finger off the touch region 240 after a lapse of preset time, a pointing operation that a user touches a certain region of the touch region 240 with a finger and takes the finger off the touch region 240 after moving in a predetermined direction and by a predetermined distance, etc.

As an example of the rotation amount information, the input device 200 may transmit values corresponding to the rotation direction and rotation angle of the upper housing 220 to the display apparatus 100. Also, as an example of the touch information, the input device 200 may transmit values corresponding to the direction and distance of the pointing operation sensed by the touch region 240 to the display apparatus 100.

Thus, the display apparatus 100 performs present operations based on the input information received from the input device 200, detailed description of which will be described later.

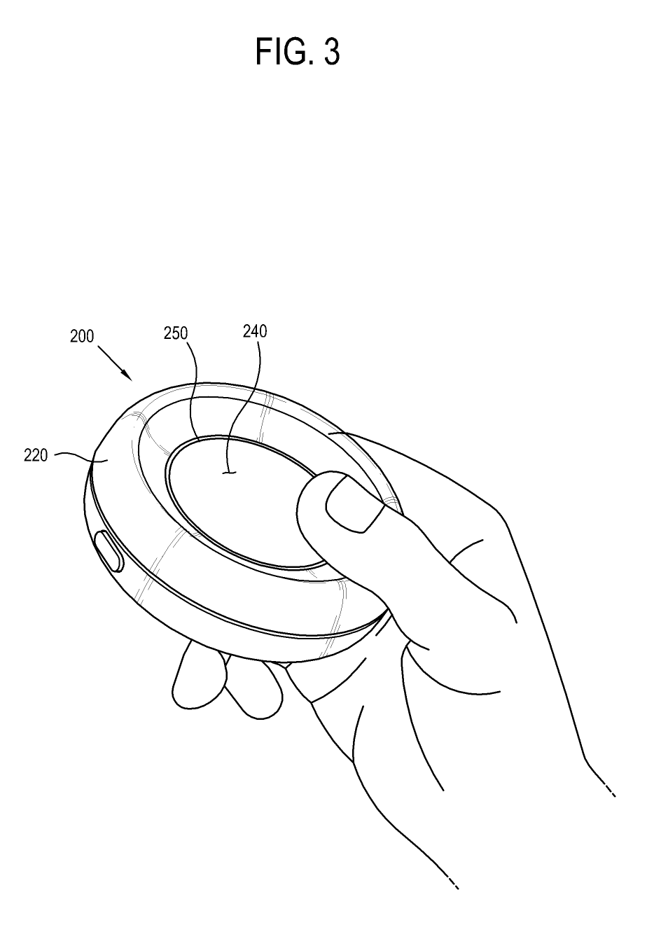

FIG. 3 shows an example where the input device 200 is gripped by a user.

Referring to FIG. 3, the input device 200 is operated by a user as being gripped by a user's one hand. FIG. 3 shows that a user rotates the upper housing 220 with a thumb and an index finger and touches the touch region 240 with the thumb while gripping the input device with his/her right hand.

A user's operation with regard to the input device 200 may be not only a single one between the rotation operation of the upper housing 220 and the touch operation of the touch region 240, but may also be both of the operations. For example, a user may rotate the upper housing 220 with his/her index finger while touching the touch region 240 with his/her thumb.

FIG. 3 shows that a user grips and operates the input device 200 with his/her right hand, but use of the input device 200 is not limited thereto. Alternatively, a user may use the input device 200 while laying it on a desk or a similar horizontal surface, or while mounting it onto a wall, a bezel (not shown) of the display apparatus 100, or a similar vertical surface.

To mount the input device 200 onto the vertical surface, the input device 200 may include an additional element. For example, the bezel (not shown) of the display apparatus 100 may be made of metal or the bezel (not shown) is internally provided with a metal plate, and a magnet is installed on a bottom of the lower housing 210 of the input device 200 so that the input device 200 can be mounted to the bezel (not shown). Such a mounting method may employ various structures, but detailed descriptions thereof will be omitted.

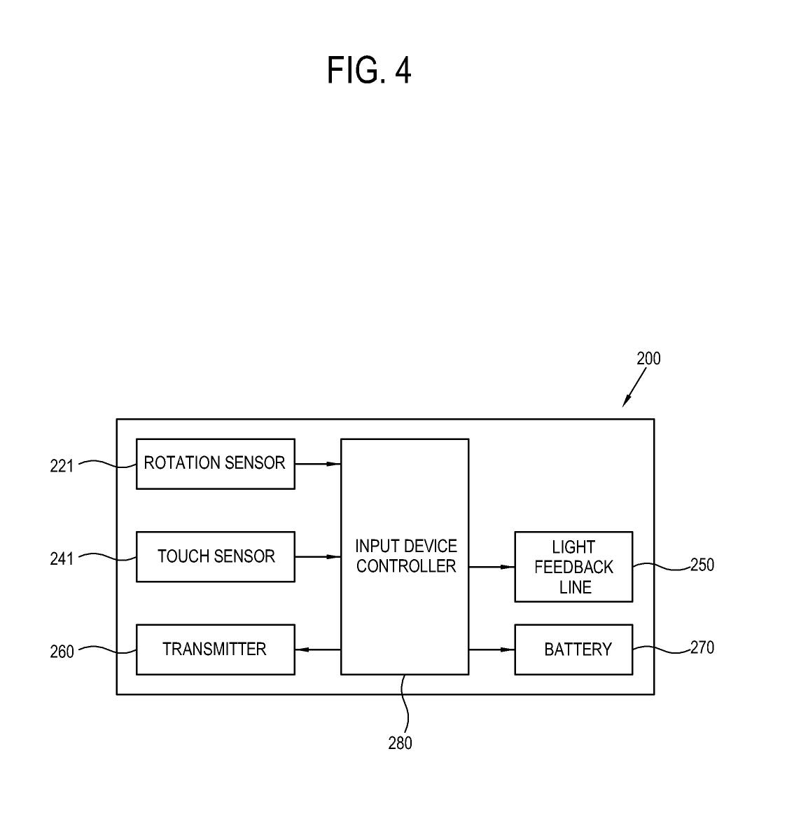

FIG. 4 is a block diagram of the input device 200.

As shown in FIG. 4, the input device 200 includes a rotation sensor 221 sensing rotation of the upper housing 220, the touch sensor 241 sensing a touch of the touch region 240, a transmitter 260 transmitting the input information to the display apparatus 100, a battery 270 supplying power to the input device 200, and an input device controller 280 generating input information in accordance with sensing results of the rotation sensor 221 and the touch sensor 241 and transmitting it to the transmitter 260. Considering that the upper housing 220 is rotatable with respect to the lower housing 210, the foregoing elements of the input device 200 may be accommodated in and supported by the lower housing 210.

The rotation sensor 221 acquires the rotation information of the upper housing 220 in accordance with the rotation of the upper housing 220. Specifically, the rotation sensor 221 senses the rotation amount of the upper housing 220 when the upper housing 220 starts to rotate, and transmits the sensing results to the input device controller 280. The rotation sensor 221 may be variously achieved as long as it can perform the foregoing functions.

In accordance with a user's touch operation on the touch region 240, the touch sensor 241 senses the touch information of the corresponding touch operation and transmits the sensing results to the input device controller 280. For example, the touch sensor 241 and the touch region 240 may be achieved corresponding to a configuration of a conventional touch pad.

The transmitter 260 transmits the input information to the display apparatus 100 through a wireless protocol such as Bluetooth, Zigbee, etc. The transmitter 260 may employ various protocols to transmit the input information, without being limited to a certain type.

The battery 270 supplies power for operating the input device 200, that is, supplies power to the rotation sensor 221, the touch sensor 241, the transmitter, the light feedback line 250, and the input device controller 280, respectively. The battery 270 has a circuit so that power can be supplied to or cut off from at least some of these elements in accordance with the states of the input device 200. Here, the power may be supplied from the battery 270 to all the elements of the input device 200, or the power may be first supplied from the battery 270 to only some elements such as the input device controller 280 and then additionally supplied from the battery 270 to the other elements in accordance with subsequent conditions.

The input device controller 280 receives sensing results of the rotation sensor 221 and the touch sensor 241 and then generates the input information based on the received sensing results. As described above, the input information includes at least one of the rotation information value of the upper housing 220 and the touch information of the touch region 240.

In particular, the input device controller 280 controls an indicating state of the light feedback line 250 in accordance with the sensing results of the rotation sensor 221. For example, the input device controller 280 controls the light emitting state of the light feedback line 250 in response to increase in the rotation value of the upper housing 220 sensed by the rotation sensor 221.

The input device controller 280 transmits the input information to the transmitter 260, so that the input information can be transmitted to the display apparatus 100 through the transmitter 260.

However, the input device 200 with this structure basically generates only two types of information, i.e., the rotation information of the upper housing 220 and the touch information of the touch region 240, and therefore the kinds of input information provided from the input device 200 to the display apparatus 100 are less than those of the related art.

The conventional remote controller or the like input device includes a plurality of physical buttons/keys, and each button is mapped to various control commands. If a user presses a certain button, a control command mapped to the corresponding button is transmitted from the input device to the display apparatus, and the display apparatus performs an operation corresponding to the received control command. Thus, it may be complicated to realize such a conventional input device because the buttons respectively corresponding to the control commands have to be installed in the input device.

Below, a method of controlling operations of the display apparatus 100 through the input device 200 operated by a user will be described according to an exemplary embodiment.

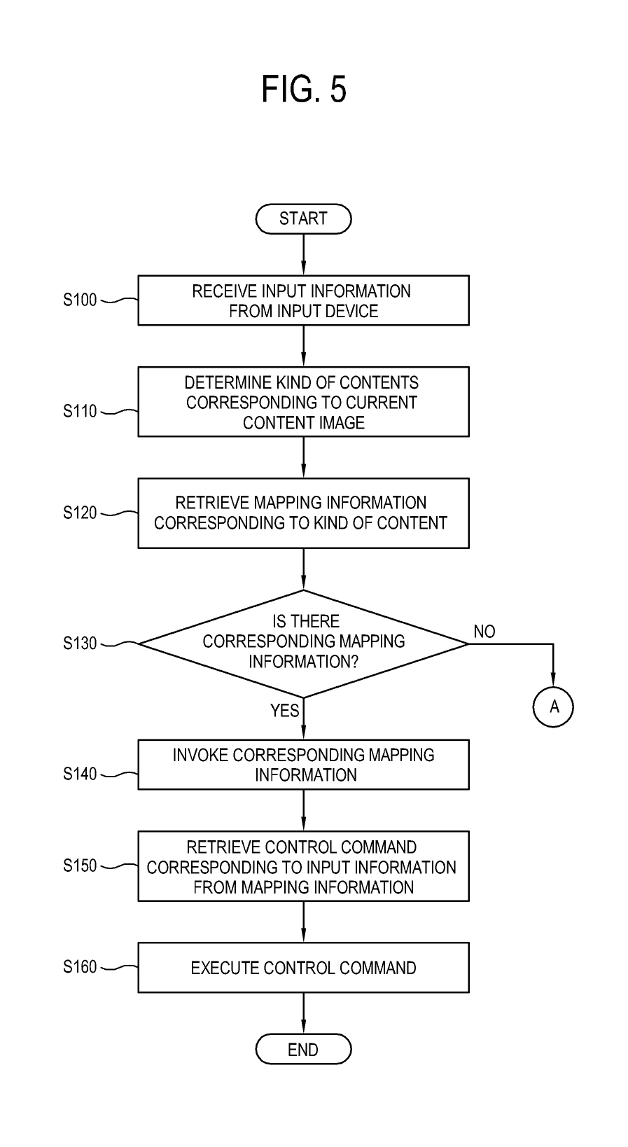

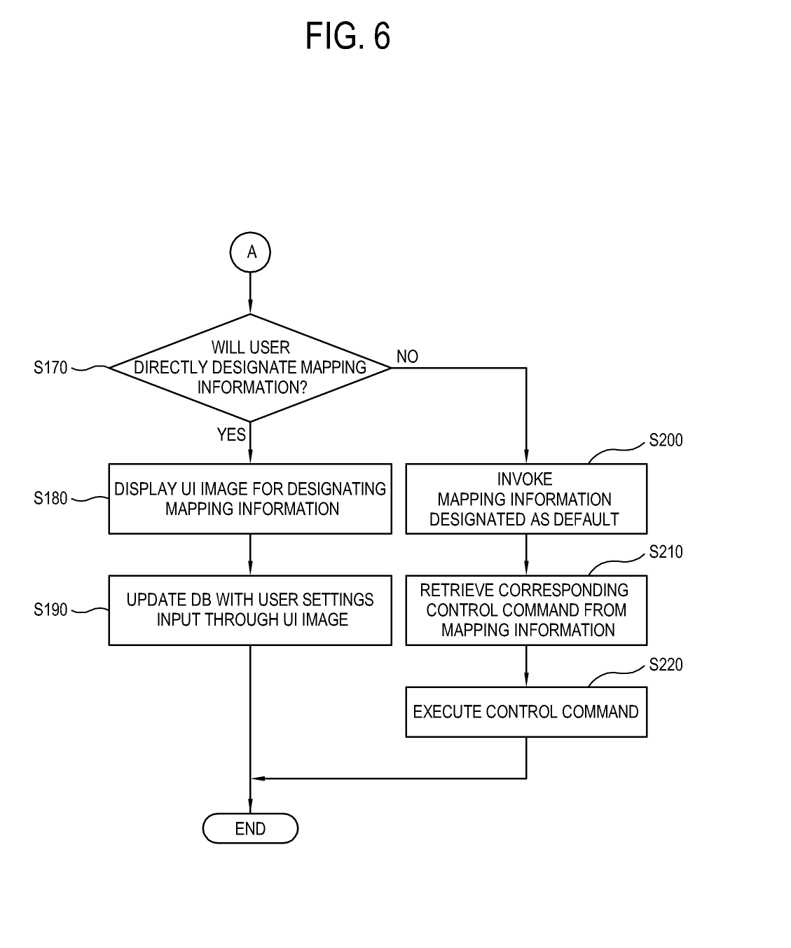

FIGS. 5 and 6 are flowcharts showing a method of controlling the display apparatus 100.

As shown in FIG. 5, the display apparatus 100 receives the input information from the input device 200 at operation S100.

At operation S110, the display apparatus 100 determines the kind of contents corresponding to the content image being currently displayed. For example, the kind of contents may include a broadcasting image, a moving image, a still image, a web page, a text document, a slide document, a UI image, etc. without limitation. Information about the kind of contents may include meta information involved in the image data to be processed, information acquired from the exterior through a separate communication route, or information acquired by the other various methods.

At operation S120, the display apparatus 100 retrieves mapping information between the control command and the input information corresponding to the kind of contents determined in the previous operation S110. Here, the control command refers to a command for controlling operations of the display apparatus 100. The mapping information is retrieved from the database previously stored in the display apparatus 100, and this database is previously designated by a manufacturer or a user.

At operation S130, the display apparatus 100 determines whether the database involves the mapping information corresponding to the determined kind of contents.

If it is determined that the database involves the corresponding mapping information, at operation S140 the display apparatus 100 invokes the corresponding mapping information. At operation S150, the display apparatus 100 retrieves the control command corresponding to the input information received in the previous operation from the invoked mapping information. At operation 5160, the display apparatus 100 executes the control command retrieved in the operation 5160.

As shown in FIG. 6, if it is determined in the operation S130 that there is no corresponding mapping information, at operation S170 the display apparatus 100 displays a message for inquiring of a user about whether s/he will directly designate the mapping information corresponding to the current kind of contents.

After displaying the message, if a user selects that s/he will designate the mapping information herself/himself, at operation S180, the display apparatus 100 displays a UI for designating the mapping information. At operation S190, the display apparatus 100 updates the database with user settings input through the UI image.

On the other hand, if a user selects that s/he will not designate the mapping information after displaying the message, the display apparatus 100 invokes the mapping information designated as a default at operation 5200, and retrieves the control command corresponding to the input information received in the previous operation from the invoked mapping information at operation 5210. At operation 5220, the display apparatus 100 executes the retrieved control command Here, the display apparatus 100 may display an error message when the control command designated as the default does not match with the kind of currently displayed contents.

As disclosed above, according to an exemplary embodiment, the mapping information between the input information and the control command is invoked in accordance with the kind of contents corresponding to the content image being currently displayed on the display apparatus 100, and the control command corresponding to the input information is retrieved from the mapping information and executed. Thus, it is easy for a user to control operations related to various types of contents through the input device 200 with a simple structure of transmitting the input information.

Below, an example of building the foregoing database will be described.

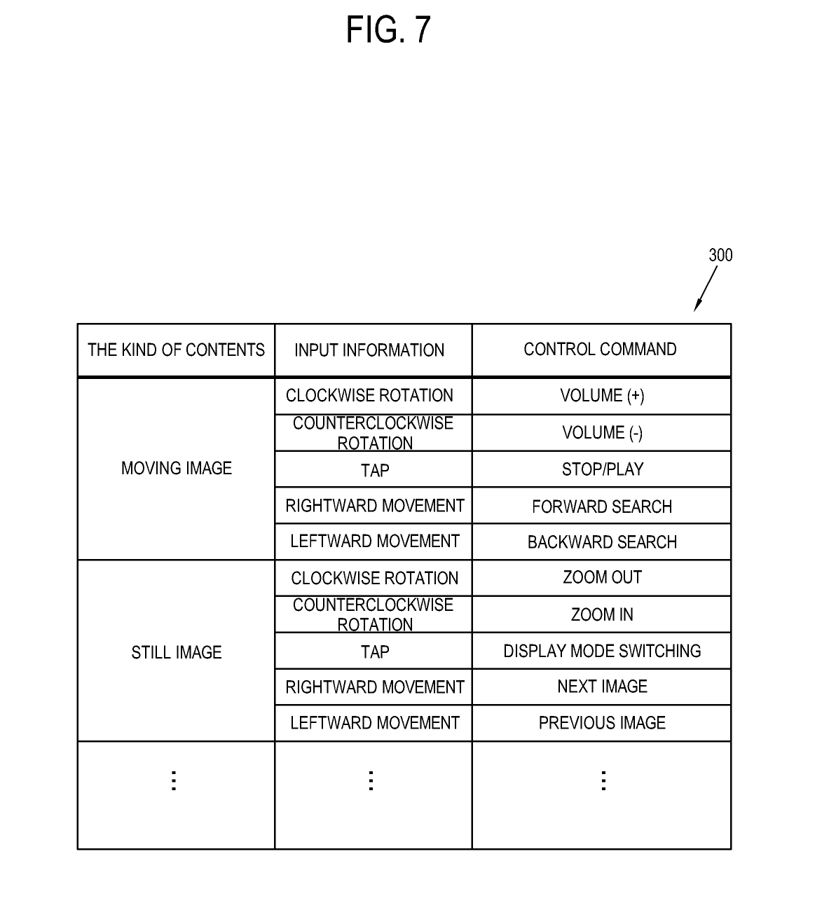

FIG. 7 shows an example of database 300 previously stored in the display apparatus 100. In this exemplary embodiment, a simple construction is described to easily explain the principle of building the database 300. However, a practical database 300 may have a complicated construction and involves more data.

As shown in FIG. 7, the database 300 is mapped so that the input information from the input device 200 can match with the control command for controlling the operations of the display apparatus 100 with regard to a certain kind of contents.

The input information receivable from the input device 200 may include “clockwise rotation”, “counterclockwise rotation”, “tap”, “rightward pointing movement”, “leftward pointing movement”, etc. Of course, additional input information (not shown) may be involved in the database 300. In particular, more various pieces of input information may be achieved in accordance with a combination between the rotation information and the touch information.

For example, if the kind of contents corresponding to an image being currently displayed on the display apparatus 100 is “the moving image”, the display apparatus 100 retrieves and invokes a record, where the kind of contents is the moving image, from the database 300. If the input information received from the input device 200 is a tap, the display apparatus 100 specifies a control command corresponding to “stop/play” based on the record invoked from the database 300. Further, the display apparatus 100 stops or plays the currently displayed moving image in accordance with the specified control command.

Meanwhile, if the kind of contents corresponding to the image being currently displayed on the display apparatus 100 is “still image”, the display apparatus 100 retrieves and invokes a record, where the kind of contents is the still image, from the database 300. In this case, if the input information received from the input device 200 is a tap, the display apparatus 100 specifies a control command corresponding to “display mode switching” based on the invoked record, and switches the display mode of the currently displayed still image in accordance with the specified control command.

As above, in the database 300, the input information about the same contents is individually mapped to the control command according to the kinds of contents. The display apparatus 100 retrieves and applies the mapping information from the database 300 in accordance with the kind of contents corresponding to the currently displayed image, thereby providing a user with a user control environment specified to the current contents.

Although it is not shown in the database 300 of FIG. 7, the database 300 may further include details of the control command with respect to each piece of input information.

For example, suppose that the kind of contents corresponds to the moving image, the input information corresponds to the clockwise rotation, and the control command corresponds to volume-up. In this case, the database 300 may involve a content related to turning the volume up by a level of ‘1’ when the rotation angle is 10 degrees. Thus, if the input information from the input device 200 corresponds to the clockwise rotation by 30 degrees, the display apparatus 100 turns the volume up by a level of ‘3’ with reference to the database 300.

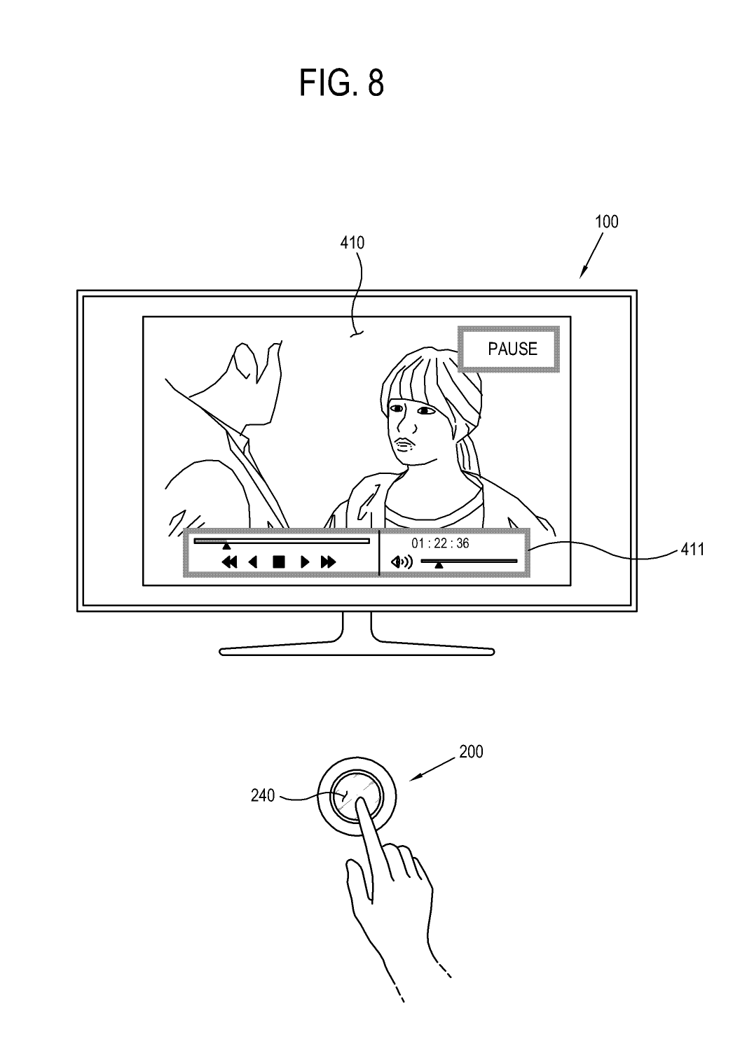

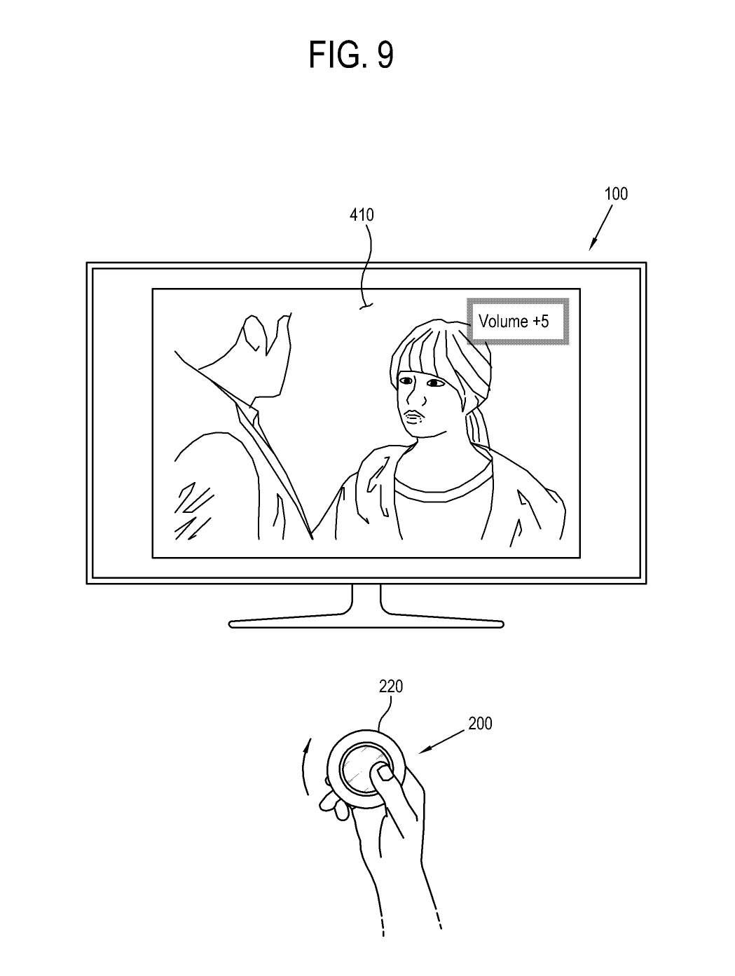

FIGS. 8 and 9 show examples where the input device 200 is operated while a moving image 410 is displayed on the display apparatus 100.

Referring to FIG. 8, suppose that a user taps the touch region 240 of the input device 200 while the moving image 410 is displayed and reproduced on the display apparatus 100.

The display apparatus 100 receives the input information corresponding to the tap operation from the input device 200. The display apparatus 100 determines that the currently displayed image is the moving image 410, and specifies the control command, which corresponds to the tap operation while the moving image 410 is being displayed, to stop/play the moving image 410.

The display apparatus 100 stops the currently reproduced moving image 410 in response to the input information since the moving image 410 is being currently reproduced. In addition, the display apparatus 100 may further display a control bar image 411 as the UI image for controlling the reproduction of the moving image 410.

Referring to FIG. 9, suppose that a user rotates the upper housing 220 of the input device 200 clockwise while the moving image 410 is displayed and reproduced on the display apparatus 100.

The display apparatus 100 receives the input information corresponding to the rotation operation from the input device 200. The display apparatus 100 determines that the currently displayed image is the moving image 410, and specifies the control command, which corresponds to the clockwise rotation operation while the moving image 410 is being displayed, to the volume up of the moving image 410.

Thus, the display apparatus 100 executes the corresponding control command to turn the volume of the moving image 410 up. At this time, the volume-up level corresponds to the rotation amount of the upper housing 220.

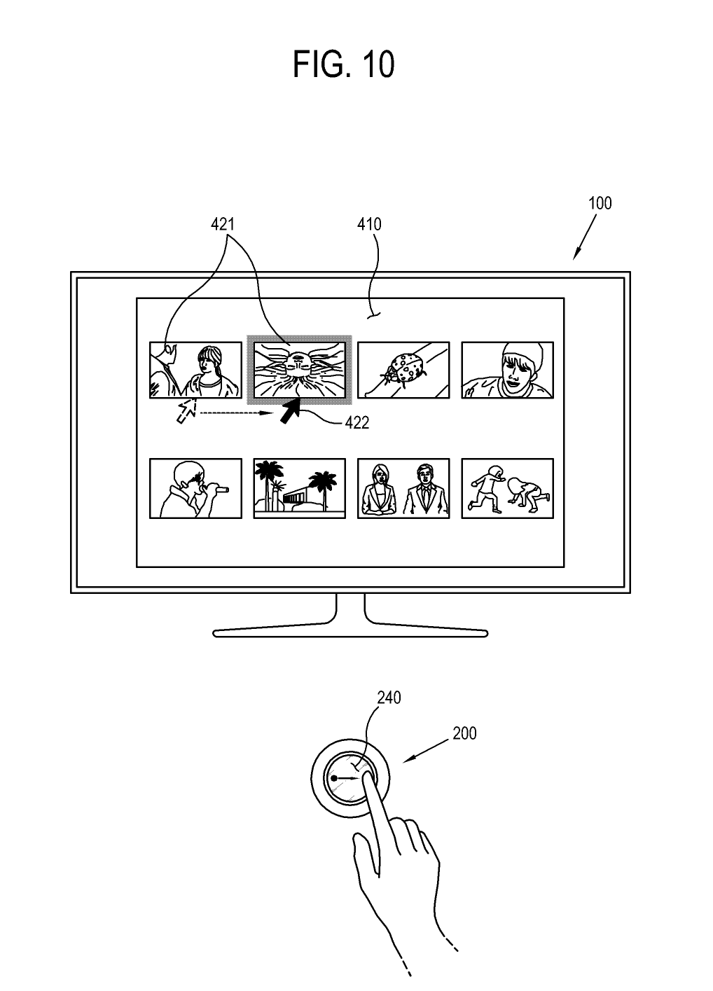

FIG. 10 shows an example where the input device 200 is operated while an UI image 420 having a thumbnail image 421 is displayed on the display apparatus 100.

Referring to FIG. 10, suppose that a user touches the touch region 240 of the input device 200 and then performs the rightward pointing movement while the display apparatus 100 is displaying the UI image 420 including the plurality of thumbnail images 421.

The display apparatus 100 receives the input information corresponding to the pointing movement operation from the input device 200. The display apparatus 100 determines that the currently displayed image is the UI image 420 including a plurality of thumbnail images 421, and correlates the control command, which corresponds to the rightward pointing movement while the UI image 420 is being displayed, to rightward movement of a cursor.

Thus, the display apparatus 100 moves a cursor 422 of the UI image 420 rightward.

With this method, the display apparatus 100 may perform an operation corresponding to the input information from the input device in accordance with the kind of contents corresponding to the currently displayed content image.

Meanwhile, the foregoing exemplary embodiments generally show the cases where the input device 200 is used as being gripped by a user, but are not limited thereto. Alternatively, the input device 200 may be used by being mounted to a certain installation surface.

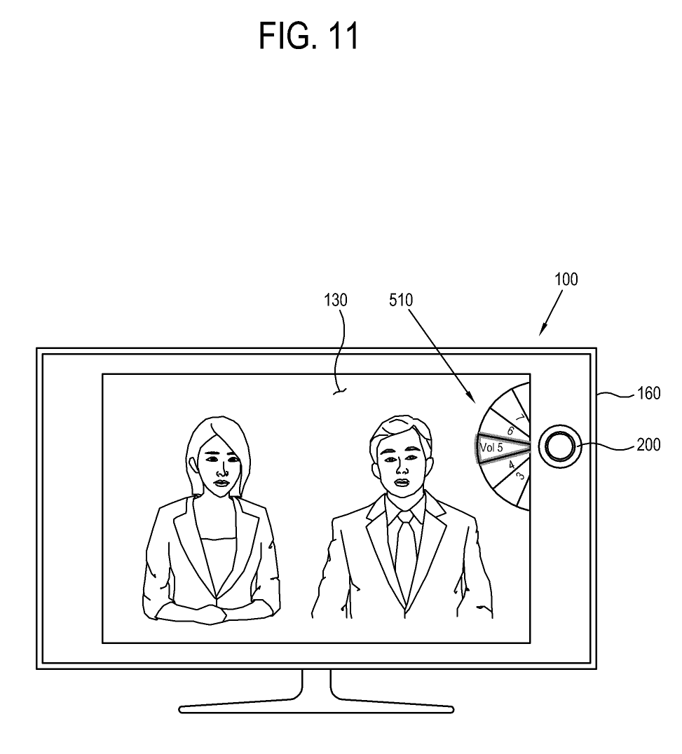

FIG. 11 shows an example where an input device 200 is mounted to a bezel 160 of a display apparatus 100 according to a second exemplary embodiment.

Referring to FIG. 11, the display apparatus 100 includes a display 130 for displaying an image on a front surface thereof, and a bezel 160 covering four edges of the display 130.

The input device 200 is provided to be mounted to and supported by a certain region of the bezel 160. The input device 200 may have various structures to be supported on the bezel 160. For example, there may be a structure where a magnet installed on the bottom of the input device 200 is attached to the bezel 160 internally provided with a metal plate, or a structure where the bezel 160 and the input device 200 respectively have portions to be engaged with each other.

A user makes the bottom of the input device 200 face with the bezel 160 and be supported on the bezel 160. In the state that the input device 200 is supported on the bezel 160, if a user operates the input device 200, the display apparatus 100 displays a menu image 510 with respect to the position of the bezel 160, where the input device 200 is supported, i.e., in the vicinity of the corresponding position.

Here, the menu image 510 shows information related to the control command corresponding to the input information of the input device 200. For example, if the control command corresponding to the input information is the volume-up, the menu image 510 includes digitized volume levels. However, the information included in the menu image 510 is not limited to such an example, and may include various pieces of information.

Also, the menu image 510 may have various shapes such as a circle, a quadrangle, etc. with respect to the input device 200.

The display apparatus 100 includes a sensor (not shown) for determining a certain position of the bezel 160, where the input device 200 is supported. The corresponding sensor (not shown) may be achieved by various well-known structures, and detailed descriptions thereof will be omitted.

The menu image 510 is displayed on the display 130 for a preset time from a point of time when a user operates the input device 200, and disappears when the preset time is elapsed. Also, the menu image 510 is not displayed when the input device 200 is separated from the bezel 160, but displayed again with respect to the supporting position of the input device 200 if the input device 200 is supported again on the bezel 160 and a user starts to operate the input device 200.

Meanwhile, the display apparatus 100 may display a plurality of pieces of content images together. In this case, the display apparatus 100 determines what content has the highest priority among the plurality of content images when receiving the input information from the input device 200.

The priority according to the contents may be previously defined according to the kinds of contents and stored in the display apparatus 100 or stored in an external device such as the server 10 accessing the display apparatus 100. The priority according to the contents may be determined by various methods, for example in order of a UI image, a moving image, a web page, a text document, and so on. However, this is nothing but an example, and does not limit the exemplary embodiments.

If the kind of contents having the highest priority is determined, the display apparatus 100 retrieves a control command corresponding to the input information, based on the determined kind of contents.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a display;
a processor configured to process a content image to be displayed on the display;
a storage configured to store a database where control commands for controlling operations of the processor corresponding to a plurality of pieces of the rotation information and a plurality of pieces of the touch information are designated according to kinds of contents; and
a controller configured to determine a kind of content corresponding to the content image being displayed on the display in response to receiving at least one from among rotation information corresponding to a user's rotating operation and touch information corresponding to a user's touching operation, from an input device, and configured to control the processor to execute a control command corresponding to the received rotation information or the received touch information from the database based on the determined kind of content.

2. The display apparatus according to claim 1, wherein the controller invokes information of the control command corresponding to at least one from among the rotation information and the touch information with regard to the determined kind of content from the database, and selects the control command corresponding to at least one from among the rotation information and the touch information received from the input device among the invoked pieces of information.

3. The display apparatus according to claim 2, wherein the controller controls to display a user interface (UI) image provided for designating information of the control command with respect to the determined kind of contents in response to the determination that the database comprises no information of the control command with respect to the determined kind of content, and updates the database with a user setting through the UI image.

4. The display apparatus according to claim 1, further comprising a bezel formed at an edge of the display,
wherein the controller detects a position of the bezel, where the input device is supportable, in response to receiving at least one from among the rotation information and the touch information from the input device while the input device is being supported at the position of the bezel, and controls to display a menu image at a position with reference to the detected position of the bezel, and
the menu image comprises information about the control command corresponding to at least one from among the received rotation information and the received touch information.

5. The display apparatus according to claim 4, wherein the controller controls to display the menu image on the display within a preset distance range from the detected position of the bezel.

6. The display apparatus according to claim 1, wherein the input device is remotely separated from the display apparatus.

7. The display apparatus according to claim 1, wherein the input device comprises:
a lower housing;
an upper housing laid on the lower housing and rotatable with respect to the lower housing;
a touch region installed on a top of the upper housing;
a sensor configured to sense rotation of the upper housing and touch of the touch region; and
an input device controller configured to generate and output at least one from among the rotation information and the touch information based on a sensing result of the sensor.

8. The display apparatus according to claim 7, wherein the sensor comprises:
a rotation sensor configured to sense a rotation direction and amount of the upper housing;
a touch sensor configured to sense a user's touch on the touch region.

9. The display apparatus according to claim 7, wherein
the input device comprises a light emitting line installed in the upper housing, and
the input device controller controls a light emitting state of the light emitting line in accordance with change in the rotation amount of the upper housing.

10. The display apparatus according to claim 9, wherein the input device controller changes a color of the light emitting line so as to control the light emitting state of the light emitting line.

11. The display apparatus according to claim 1, wherein the controller determines the kind of content having the highest priority in a previously designated order among a plurality of content images in response to receiving at least one from among the rotation information and the touch information from the input device while the plurality of content images are displayed together on the display, and searches the control command based on the determined kind of content.

12. A method of controlling a display apparatus, the method comprising:
displaying a content image;
receiving at least one from among rotation information corresponding to a user's rotating operation and touch information corresponding to a user's touching operation from an input device;
determining a kind of content corresponding to the displayed content image; and
executing a control command corresponding to at least one from among the rotation information and the touch information received from the input device based on the determined kind of content, from a database where control commands for controlling operations of the processor corresponding to a plurality of pieces of the rotation information and a plurality of pieces of the touch information are designated according to kinds of content.

13. The method according to claim 12, wherein the executing the control command comprises:
invoking information of the control command corresponding to at least one from among the rotation information and the touch information with regard to the determined kind of content from the database; and
selecting the control command corresponding to the at least one from among rotation information and the touch information received from the input device among the invoked pieces of information.

14. The method according to claim 12, wherein the executing the control command comprises:
displaying a user interface (UI) image provided for designating information related to the control command with respect to a determined kind of content in response to a determination that the database comprises no information of the control command with respect to the determined kind of content; and
updating the database with a user setting through the UI image.

15. The method according to claim 12, further comprising:
detecting a position of a bezel where the input device is supported, in response to receiving at least one from among the rotation information and the touch information from the input device while the input device is being supported at the position of the bezel of the display apparatus; and
displaying a menu image at a position with reference to the detected position of the bezel,
wherein the menu image comprises information related to the control command corresponding to the at least one from among received rotation information and the received touch information.

16. The method according to claim 15, wherein the displaying the menu image comprises displaying the menu image on the display within a preset distance range from the detected position of the bezel.

17. The method according to claim 12, wherein the determining the kind of content corresponding to the displayed content image comprises determining the kind of content having a highest priority in a previously designated order among a plurality of content images, in response to receiving at least one from among the rotation information and the touch information from the input device while the plurality of content images are displayed together on the display apparatus.

18. A system comprising:
a display apparatus; and
an input device configured to output at least one from among rotation information corresponding to a user's rotating operation and touch information corresponding to a user's touching operation,
wherein the display apparatus comprises:
a processor configured to process a content image to be displayed on the display;
a storage configured to store a database where control commands for controlling operations of the processor corresponding to a plurality of pieces of the rotation information and a plurality of pieces of the touch information are designated according to kinds of contents; and
a controller configured to determine a kind of content corresponding to the content image being displayed on the display in response to receiving at least one from among the rotation information and the touch information, from an input device, and configured to control the processor to execute a control command corresponding to the received rotation information or the received touch information from the database based on the determined kind of content.

19. The system according to claim 18, wherein the input device is mountable on the display apparatus.

20. The system according to claim 1, wherein the controller invokes information of the control command corresponding to at least one from among the rotation information and the touch information with regard to the determined kind of content from the database, and selects the control command corresponding to at least one from among the rotation information and the touch information received from the input device among the invoked pieces of information.
